(19) United States
(12) Patent Application Publication
(10) Pub. No.: US 2018/0027451 A1
(43) Pub. Date: Jan. 25, 2018

(54) SERVICE TRAFFIC STEERING METHOD, DEVICE AND SYSTEM

(71) Applicant: China Mobile Communications Corporation, Beijing (CN)

(72) Inventors: Tao Sun, Beijing (CN); Wei Chen, Beijing (CN); Lu Lu, Beijing (CN); Hui Deng, Beijing (CN)

(21) Appl. No.: 15/724,656

(22) Filed: Oct. 4, 2017

Related U.S. Application Data
(63) Continuation of application No. PCT/CN2016/078578, filed on Apr. 6, 2016.

(30) Foreign Application Priority Data
Apr. 7, 2015 (CN) 201510159690.X

(51) Int. Cl. H04W 28/10; H04L 12/813; H04W 24/02; H04L 12/851

(52) U.S. Cl. CPC H04W 28/10; H04L 47/2441; H04L 47/20; H04W 24/02

(57) ABSTRACT

A service traffic steering method, device and system are provided. The method includes that: a steering path identifier of a downlink service traffic is identified according to a service traffic steering policy; and the steering path identifier of the downlink service traffic and description information of the downlink service traffic are sent to a downlink classifier to enable the downlink classifier to mark the downlink service traffic according to the steering path identifier of the downlink service traffic, an uplink classifier and the downlink classifier are deployed in different network devices.

### CROSS-REFERENCE TO RELATED APPLICATIONS

The disclosure is a continuation application of International Application No. PCT/CN2016/078578 filed on Apr. 6, 2016, which claims priority to Chinese Application No. 201510159690.X, filed on Apr. 7, 2015. The applications are hereby incorporated by reference in their entirety.

### TECHNICAL FIELD

The disclosure relates to the technical field of traffic steering, and particularly to a service traffic steering method, device and system.

### BACKGROUND

Along with development of mobile Internet, an operator is intended to deploy more and more traffic processing value-added devices in a Gi-Local Area Network (Gi-LAN) behind a gateway, for example, video optimization device, protocol optimization device, information recommendation information, cache device and a firewall. For traffic, not all traffic is required to pass through all the traffic processing value-added devices, but only part of traffic is required to be processed by part of the value-added devices according to a service chain policy of the operator. Under such a background, a service chain mechanism is proposed, that is, traffic is steered to pass through different value-added devices on demand, so that networking flexibility is improved, and a traffic burden or deployment cost of the value-added devices is reduced. Different service chain identifiers correspond to different data flow processing paths.

There are a great variety of such traffic processing value-added devices with different characteristics: some processing devices is only required to process uplink traffic (for example, enhancement of some Hyper Text Transport Protocol (HTTP) data packet headers), some devices is only required to process downlink traffic (for example, video optimization and content compression), and some other devices is required to process uplink and downlink traffic (for example, content-based charging).

For some traffic, uplink traffic may be identified and analyzed by Deep Packet Inspection (DPI) to judge characteristics of the traffic and determine service chains through which the uplink traffic and downlink traffic should pass respectively. For some other traffic, downlink traffic is also required to be analyzed by DPI to identify characteristics of the traffic and determine service chains through which the traffic should pass.

Unfortunately, there is no deep analysis on these service characteristics and no related researches on classification and optimization of downlink traffic processing manners in a current technology. A current solution adopts a classifier-based implementation manner, and all uplink and downlink traffic passes through a classifier at first, as shown in FIG. 1, which is not so optimal particularly for a mobile network. This means that downlink traffic is identified by a Packet Data Network (PDN) Gateway (PGW) or a Traffic Detection Function (TDF) at first, then is subjected to service processing at a Gi-LAN, and is returned to the PGW for sending to a user.

Thus it can be seen that most of solutions in a related technology are implemented on the basis of a single classifier and still have the following problems, although being capable of meeting requirements on networking flexibility and cost reduction.

First, there is no analysis made in combination with a service characteristic. For example, for some traffic, uplink traffic may be identified and analyzed to judge characteristics of the traffic and determine service chains through which the uplink traffic and downlink traffic should pass respectively. For some other traffic, downlink traffic is also required to be analyzed to identify characteristics of the traffic and determine service chains through which the traffic should pass. Adopting the same processing manner may cause unnecessary resource consumption.

Second, adopting a single classifier makes a load excessively high and easily causes a single-point failure. Some traffic characteristics may be identified only by combining uplink and downlink traffic, but if each piece of traffic passes through the same classifier, there is pressure on the classifier, and a traffic bottleneck easily occurs.

Third, a route is roundabout. Downlink traffic reaches a TDF or a PGW from a Gi-LAN, then returns to the Gi-LAN for processing, and is sent to a user after returning to the TDF (PGW). Such a manner makes the route not so optimal.

### SUMMARY

Embodiments of the disclosure are intended to provide a service traffic steering method, device and system, which may reduce overhead brought by passing of uplink service traffic and downlink service traffic through the same classifier and improve a processing capacity of a network system.

In order to achieve the purpose, the embodiments of the disclosure provide a service traffic steering method, which may be applied to an uplink classifier, the method including that:

a steering path identifier of a downlink service traffic is identified according to a service traffic steering policy; and

the steering path identifier of the downlink service traffic and description information of the downlink service traffic are sent to a downlink classifier to enable the downlink classifier to mark the downlink service traffic according to the steering path identifier of the downlink service traffic, the uplink classifier and the downlink classifier may be deployed in different network devices.

Optionally, the step that the steering path identifier of the downlink service traffic is identified according to the service traffic steering policy may include that:

when the steering path identifier of the downlink service traffic can be directly identified according to an uplink service traffic, the uplink service traffic is directly identified to obtain the steering path identifier of the downlink service traffic according to the service traffic steering policy.

Optionally, the step that the steering path identifier of the downlink service traffic is identified according to the service traffic steering policy may include that:

when the steering path identifier of the downlink service traffic cannot be directly identified according to the uplink service traffic, the downlink service traffic is received; and

states of the uplink service traffic and the downlink service traffic are considered jointly to identify the steering path identifier of the downlink service traffic according to the service traffic steering policy.

Optionally, the step that the steering path identifier of the downlink service traffic and the description information of the downlink service traffic are sent to the downlink classifier may include that:

the steering path identifier of the downlink service traffic and the description information of the downlink service traffic are sent to the downlink classifier through signaling interface(s).

Optionally, the step that the steering path identifier of the downlink service traffic and the description information of the downlink service traffic are sent to the downlink classifier may include that:

the steering path identifier of the downlink service traffic and the description information of the downlink service traffic are sent to the downlink classifier through a policy controller.

Optionally, the step that the steering path identifier of the downlink service traffic and the description information of the downlink service traffic are sent to the downlink classifier may include that:

a data packet is steered to the downlink classifier through a network, the data packet containing the steering path identifier of the downlink service traffic and the description information of the downlink service traffic.

The embodiments of the disclosure further provide a service traffic steering device, which may be applied to an uplink classifier, the device including:

an identification module, configured to identify a steering path identifier of a downlink service traffic according to a service traffic steering policy; and

a sending module, configured to send the steering path identifier of the downlink service traffic and description information of the downlink service traffic to a downlink classifier to enable the downlink classifier to mark the downlink service traffic according to the steering path identifier of the downlink service traffic, wherein the uplink classifier and the downlink classifier may be deployed in different network devices.

Optionally, the identification module may include:

a first obtaining unit, configured to, when the steering path identifier of the downlink service traffic can be directly identified according to an uplink service traffic, directly identify the uplink service traffic to obtain the steering path identifier of the downlink service traffic according to the service traffic steering policy.

Optionally, the identification module may include:

a first unit, configured to, when the steering path identifier of the downlink service traffic cannot be directly identified according to the uplink service traffic, receive the downlink service traffic; and

a second obtaining unit, configured to identify states of the uplink service traffic and downlink service traffic jointly to obtain the steering path identifier of the downlink service traffic according to the service traffic steering policy.

Optionally, the sending module may include:

a second unit, configured to send the steering path identifier of the downlink service traffic and the description information of the downlink service traffic to the downlink classifier through signaling interface(s).

Optionally, the sending module may include:

a third unit, configured to send the steering path identifier of the downlink service traffic and the description information of the downlink service traffic to the downlink classifier through a policy controller.

Optionally, the sending module may include:

a fourth unit, configured to steer a data packet to the downlink classifier through a network, the data packet containing the steering path identifier of the downlink service traffic and the description information of the downlink service traffic.

The embodiments of the disclosure further provide an uplink classifier, which may include the abovementioned service traffic steering device.

The embodiments of the disclosure further provide a PDN gateway, which may include the abovementioned uplink classifier.

The embodiments of the disclosure further provide a traffic detection function, which may include the abovementioned uplink classifier.

The embodiments of the disclosure further provide a service traffic steering method, which may be applied to a downlink classifier, the method including that:

a steering path identifier of a downlink service traffic and description information of the downlink service traffic are received from an uplink classifier; and

the downlink service traffic is marked according to the steering path identifier of the downlink service traffic and the description information of the downlink service traffic, wherein the uplink classifier and the downlink classifier may be deployed in different network devices.

Optionally, before the step that the steering path identifier of the downlink service traffic and the description information of the downlink service traffic are received from the uplink classifier, the method may further include that:

the downlink service traffic is received;

it is determined that no steering path identifier corresponding to the downlink service traffic is recorded per se; and

the downlink service traffic is steered to the uplink classifier to enable the uplink classifier to identify the steering path identifier of the downlink service traffic. Optionally, the step that the steering path identifier of the downlink service traffic and the description information of the downlink service traffic are received from the uplink classifier may include that:

the steering path identifier of the downlink service traffic and the description information of the downlink service traffic are received from the uplink classifier through signaling interface(s).

Optionally, the step that the steering path identifier of the downlink service traffic and the description information of the downlink service traffic are received from the uplink classifier may include that:

the steering path identifier of the downlink service traffic and the description information of the downlink service traffic are received from the uplink classifier through a policy controller.

Optionally, the step that the steering path identifier of the downlink service traffic and the description information of the downlink service traffic are received from the uplink classifier may include that:

a data packet steered by the uplink classifier through a network is received, the data packet containing the steering path identifier of the downlink service traffic and the description information of the downlink service traffic; and

the steering path identifier of the downlink service traffic and the description information of the downlink service traffic are acquired from the data packet.

The embodiments of the disclosure further provide a service traffic steering device, which may be applied to a downlink classifier, the device including:

a receiving module, configured to receive a steering path identifier of a downlink service traffic and description information of the downlink service traffic from an uplink classifier; and

a marking module, configured to mark the downlink service traffic according to the steering path identifier of the downlink service traffic and the description information of the downlink service traffic, wherein the uplink classifier and the downlink classifier may be deployed in different network devices.

Optionally, the device may further include:

a fifth unit, configured to receive the downlink service traffic;

a sixth unit, configured to determine that no steering path identifier corresponding to the downlink service traffic is recorded per se; and

a seventh unit, configured to steer the downlink service traffic to the uplink classifier to enable the uplink classifier to identify the steering path identifier of the downlink service traffic.

Optionally, the receiving module may include:

an eighth unit, configured to receive the steering path identifier of the downlink service traffic and the description information of the downlink service traffic from the uplink classifier through signaling interface(s).

Optionally, the receiving module may include:

a ninth unit, configured to receive the steering path identifier of the downlink service traffic and the description information of the downlink service traffic from the uplink classifier through a policy controller.

Optionally, the receiving module may include:

a tenth unit, configured to receive a data packet steered by the uplink classifier through a network, the data packet containing the steering path identifier of the downlink service traffic and the description information of the downlink service traffic; and

an eleventh unit, configured to acquire the steering path identifier of the downlink service traffic and the description information of the downlink service traffic from the data packet.

The embodiments of the disclosure further provide a downlink classifier, which may include the abovementioned service traffic steering device.

The embodiments of the disclosure further provide a service traffic steering system, which may include the abovementioned uplink classifier, the abovementioned downlink classifier and a policy controller,

the policy controller being configured to receive a steering path identifier of a downlink service traffic and description information of the downlink service traffic from the uplink classifier and send the steering path identifier of the downlink service traffic and the description information of the downlink service traffic to the downlink classifier.

Optionally, the policy controller may have the steering path identifier of the downlink service traffic and the description information of the downlink service traffic, and may further be configured to send the steering path identifier of the downlink service traffic and the description information of the downlink service traffic to the downlink classifier.

Optionally, the downlink classifier may further be configured to receive the steering path identifier of the downlink service traffic and the description information of the downlink service traffic from the policy controller.

Optionally, the policy controller may further be configured to, when the steering path identifier of the downlink service traffic is required to be updated, send an updating rule to the downlink classifier. The solutions of the disclosure at least have the following beneficial effects.

In the embodiments of the disclosure, after identifying the steering path identifier of the downlink service traffic, the uplink classifier may send the steering path identifier of the downlink service traffic and the description information of the downlink service traffic to the downlink classifier to enable the downlink classifier to mark the downlink service traffic, thereby reducing overhead brought by passing of uplink service traffic and downlink service traffic through the same classifier and improving a processing capacity of a network system.

### BRIEF DESCRIPTION OF DRAWINGS

In order to describe the technical solutions in the embodiments of the disclosure or the related technology more clearly, the drawings required to be used for description about the embodiments will be simply introduced below. Obviously, the drawings described below are only some embodiments of the disclosure. Those skilled in the art may further obtain other drawings according to these drawings without creative work.

FIG. 1 is a schematic diagram of PGW or TDF-based service traffic steering according to the related technology;

FIG. 2 is a step flowchart of a service traffic steering method applied to an uplink classifier according to an embodiment of the disclosure;

FIG. 3 is a schematic diagram of a service traffic steering method for an uplink classifier deployed on a PGW according to an embodiment of the disclosure;

FIG. 4 is a schematic diagram of a service traffic steering method for an uplink classifier deployed on a TDF according to an embodiment of the disclosure;

FIG. 5 is a schematic diagram of a service traffic steering device applied to an uplink classifier according to an embodiment of the disclosure;

FIG. 6 is a step flowchart of a service traffic steering method applied to a downlink classifier according to an embodiment of the disclosure; and

FIG. 7 is a schematic diagram of a service traffic steering device applied to a downlink classifier according to an embodiment of the disclosure.

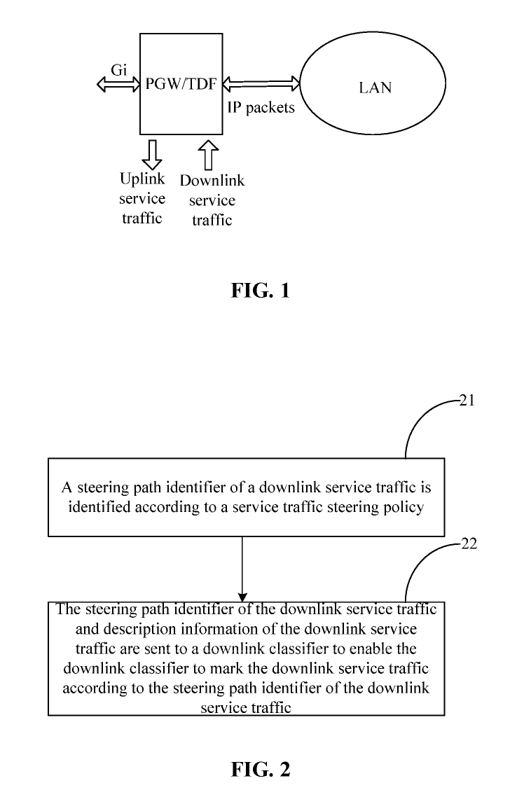

### DETAILED DESCRIPTION

In order to make the technical problem to be solved, technical solutions and advantages of the disclosure clearer, detailed descriptions will be made below in combination with the drawings and specific embodiments.

For the problem of high overhead brought by passing of uplink service traffic and downlink service traffic through the same classifier in the related technology, the disclosure provides a service traffic steering method, device and system, which may reduce the overhead brought by passing of the uplink service traffic and downlink service traffic through the same classifier and improve a processing capacity of a network system.

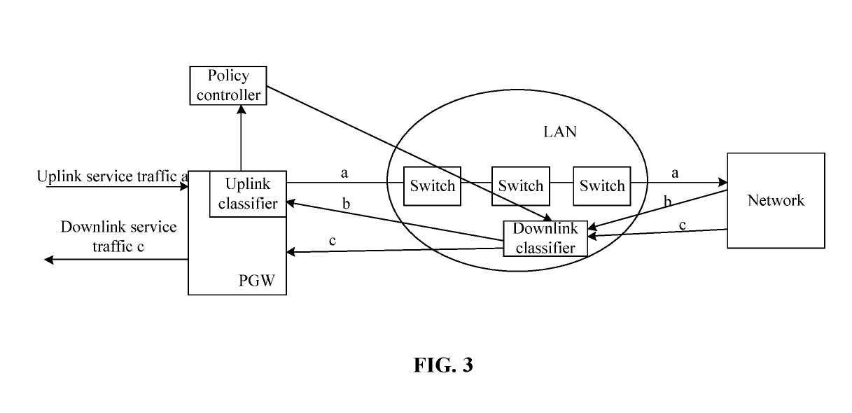

As shown in FIG. 2, an embodiment of the disclosure provides a service traffic steering method, which is applied to an uplink classifier, the method including the following steps.

In Step 21, a steering path identifier of a downlink service traffic is identified according to a service traffic steering policy.

In Step 22, the steering path identifier of the downlink service traffic and description information of the downlink service traffic are sent to a downlink classifier to enable the downlink classifier to mark the downlink service traffic according to the steering path identifier of the downlink service traffic, herein the uplink classifier and the downlink classifier are deployed in different network devices, the uplink classifier may further send the description information of the downlink service traffic to the downlink classifier at the same time of sending the steering path identifier of the downlink service traffic to the downlink classifier, and the description information of the downlink service traffic includes a for example 5-tuple of the downlink service traffic.

Optionally, in the embodiment of the disclosure, before Step 22 is executed, the method further includes that: it is determined that the steering path identifier of the downlink service traffic and the description information of the downlink service traffic are required to be sent to the downlink classifier according to a preset judgment rule.

In a specific embodiment of the disclosure, before sending the steering path identifier of the downlink service traffic and the description information of the downlink service traffic to the downlink classifier, the uplink classifier is required to judge whether it is necessary to send the steering path identifier of the downlink service traffic and the description information of the downlink service traffic to the downlink classifier according to the judgment rule preset by itself. Specifically, it is judged whether the Internet Protocol (IP) 5-tuple or partial information thereof of the downlink service traffic can be identified and whether the Internet Protocol (IP) 5-tuple or partial information thereof of the downlink service traffic clearly correspond to the downlink service traffic, if both results of the judgements is yes, it is determined that the steering path identifier of the downlink service traffic and the description information of the downlink service traffic need to be sent to the downlink classifier, and if neither result of the judgements is no, it is determined that there is no need to send the steering path identifier of the downlink service traffic and the description information of the downlink service traffic to the downlink classifier.

Optionally, in the embodiment of the disclosure, there are multiple specific implementation manners for Step 21, and correspondingly, there are also multiple specific implementation manners for Step 22. Specifically, a first implementation manner for Step 21 is that: when the steering path identifier of the downlink service traffic may be directly identified according to an uplink service traffic, the uplink service traffic is directly identified to obtain a steering path identifier of the uplink service traffic and the steering path identifier of the downlink service traffic according to the service traffic steering policy. A second implementation manner for Step 21 is that: when the steering path identifier of the downlink service traffic may not be directly identified according to the uplink service traffic, the uplink service traffic is identified to obtain the steering path identifier of the uplink service traffic according to the service traffic steering policy; the downlink service traffic steered by a network through the downlink classifier (or directly steered by the network) is received; and states of the uplink service traffic and the downlink service traffic are considered jointly to identify the steering path identifier of the downlink service traffic according to the service traffic steering policy. Correspondingly, a first implementation manner for Step 22 is that: the steering path identifier of the downlink service traffic and the description information of the downlink service traffic are sent to the downlink classifier through signaling interface(s) or a policy controller, herein the policy controller may be a Policy and Charging Rules Function (PCRF) in a mobile network or a controller in a Software Defined Network (SDN). A second implementation manner for Step 22 is that: a data packet is steered to the downlink classifier through the network, the data packet containing the steering path identifier of the uplink service traffic, the steering path identifier of the downlink service traffic and the description information of the downlink service traffic.

In a specific embodiment of the disclosure, a content load of the data packet sent by the uplink classifier may be null.

In a specific embodiment of the disclosure, since Steps 21 and 22 are each provided with two implementation manners, the embodiment of the disclosure should have at least four implementation manners.

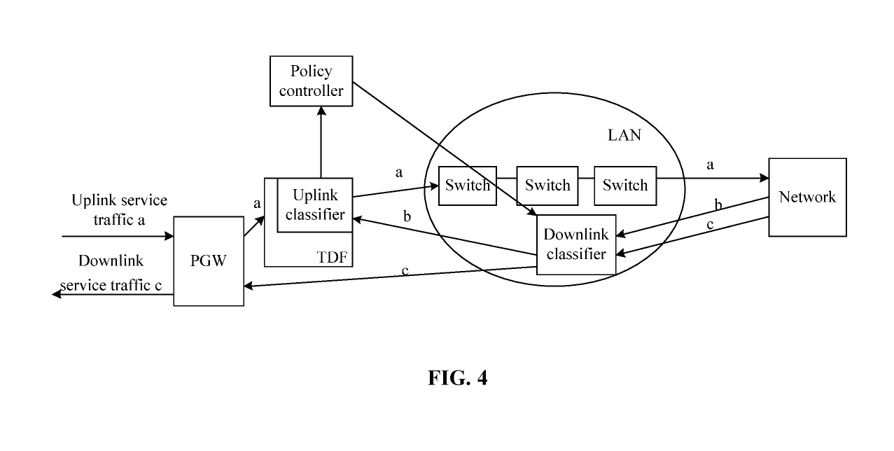

In a specific embodiment of the disclosure, as shown in FIG. 3˜FIG. 4, on the basis of the first implementation manner for Step 21 and the first implementation manner for Step 22, the uplink classifier may be deployed on a PGW or a TDF. When an uplink service traffic (i.e. “a” in FIG. 3 and FIG. 4) reaches the uplink classifier configured with the service traffic steering policy, the uplink classifier analyzes the uplink service traffic to obtain a steering path identifier of the uplink service traffic and a steering path identifier of a downlink service traffic according to the service traffic steering policy, and marks the uplink service traffic with the steering path identifier of the uplink service traffic. At this moment, the uplink classifier may send the steering path identifier of the downlink service traffic and description information of the downlink service traffic to the downlink classifier through signaling interface(s) or the policy controller. Thereafter, if the related downlink service traffic (i.e. “c” in FIG. 3 and FIG. 4) reaches the downlink classifier, the downlink classifier may identify the downlink service traffic and mark the downlink service traffic with the corresponding steering path identifier. If the downlink steering path identifier is subsequently required to be changed, the policy controller may notify the downlink classifier of updating the steering path identifier of the downlink service traffic to steer the change a corresponding path of the downlink service traffic, herein, if the uplink classifier is deployed on the PGW, the uplink classifier may send the steering path identifier of the downlink service traffic and description information of the downlink service traffic to the policy controller through a Gx interface, and if the uplink classifier is deployed on the TDF, the uplink classifier may send the steering path identifier of the downlink service traffic and description information of the downlink service traffic to the policy controller through an Sd interface.

In a specific embodiment of the disclosure, as shown in FIG. 3˜FIG. 4, on the basis of the second implementation manner for Step 21 and the first implementation manner for Step 22, the uplink classifier may be deployed on the PGW or the TDF. When an uplink service traffic (i.e. “a” in FIG. 3 and FIG. 4) reaches the uplink classifier configured with the service traffic steering policy, the uplink classifier analyzes the uplink service traffic to obtain a steering path identifier of the uplink service traffic according to the service traffic steering policy, and marks the uplink service traffic with the steering path identifier of the uplink service traffic. At this moment, the uplink classifier has yet not identified a steering path identifier of a downlink service traffic, so that the uplink classifier is required to identify the steering path identifier of the downlink service traffic in combination with states of the downlink service traffic (i.e. “b” in FIG. 3 and FIG. 4) steered by the downlink classifier and the uplink service traffic. After the uplink classifier identifies the steering path identifier of the downlink service traffic, the uplink classifier may send the steering path identifier of the downlink service traffic and description information of the downlink service traffic to the downlink classifier through signaling interface(s) or the policy controller. Thereafter, if the related downlink service traffic (i.e. “c” in FIG. 3 and FIG. 4) reaches the downlink classifier, the downlink classifier may identify the downlink service traffic and mark the downlink service traffic with the corresponding steering path identifier. Similar to the above, if the downlink steering path identifier is subsequently required to be changed, the policy controller may notify the downlink classifier of updating the steering path identifier of the downlink service traffic to steer the change a corresponding path of the downlink service traffic, herein, if the uplink classifier is deployed on the PGW, the uplink classifier may send the steering path identifier of the downlink service traffic and description information of the downlink service traffic to the policy controller through a Gx interface, and if the uplink classifier is deployed on the TDF, the uplink classifier may send the steering path identifier of the downlink service traffic and description information of the downlink service traffic to the policy controller through an Sd interface.

In a specific embodiment of the disclosure, as shown in FIG. 3˜FIG. 4, on the basis of the first implementation manner for Step 21 and the second implementation manner for Step 22, when an uplink service traffic (i.e. “a” in FIG. 3 and FIG. 4) reaches the uplink classifier configured with the service traffic steering policy, the uplink classifier analyzes the uplink service traffic to obtain a steering path identifier of the uplink service traffic and a steering path identifier of a downlink service traffic according to the service traffic steering policy, and marks the uplink service traffic with the steering path identifier of the uplink service traffic. At this moment, the uplink classifier may steer a data packet (the data packet contains the steering path identifier of the uplink service traffic, the steering path identifier of the downlink service traffic and description information of the downlink service traffic) to a subsequent Gi-LAN, then the uplink service traffic is processed by a corresponding service function, that is, the Gi-LAN schedules and steers the uplink service traffic to a corresponding service function unit for value-added service on the basis of the steering path identifier of the uplink service traffic, and then the data packet is steered to the downlink classifier. After receiving the data packet, the downlink classifier may acquire and record the steering path identifier of the downlink service traffic and description information of the downlink service traffic in the data packet. Thereafter, if the related downlink service traffic (i.e. “c” in FIG. 3 and FIG. 4) reaches the downlink classifier, the downlink classifier may identify the downlink service traffic, mark the downlink service traffic with the corresponding steering path identifier and steer the marked downlink service traffic to the Gi-LAN for corresponding service. Herein, if the uplink classifier is deployed on the PGW, a specific identification flow is as mentioned above, and if the PGW in the network has no traffic identification function but the TDF is deployed and the TDF has the traffic identification function, the uplink classifier may be deployed on the TDF, but a specific identification flow has the following difference: first, a service traffic subjected to downlink value-added service is directly steered to the PGW, and the TDF only processes an uplink service traffic and an uplink and downlink jointly detected service traffic.

In a specific embodiment of the disclosure, as shown in FIG. 3˜FIG. 4, on the basis of the second implementation manner for Step 21 and the second implementation manner for Step 22, when an uplink service traffic (i.e. “a” in FIG. 3 and FIG. 4) are steered to the uplink classifier configured with the service traffic steering policy, the uplink classifier analyzes the uplink service traffic to obtain a steering path identifier of the uplink service traffic according to the service traffic steering policy, and marks the uplink service traffic with the steering path identifier of the uplink service traffic. At this moment, the uplink classifier has yet not identified a steering path identifier of a downlink service traffic, so that the uplink classifier is required to identify the steering path identifier of the downlink service traffic in combination with states of the downlink service traffic (i.e. “b” in FIG. 3 and FIG. 4) steered by the downlink classifier and the uplink service traffic. After the uplink classifier identifies the steering path identifier of the downlink service traffic, the uplink classifier may send a data packet (the data packet contains the steering path identifier of the uplink service traffic, the steering path identifier of the downlink service traffic and description information of the downlink service traffic) to a subsequent Gi-LAN, then the uplink service traffic is processed by certain corresponding service function (s), that is, the Gi-LAN schedules and steers the uplink service traffic to a corresponding service function unit for value-added service on the basis of the steering path identifier of the uplink service traffic, and then the data packet is steered to the downlink classifier. After receiving the data packet, the downlink classifier may acquire and record the steering path identifier of the downlink service traffic and description information of the downlink service traffic in the data packet. Thereafter, if the related downlink service traffic (i.e. “c” in FIG. 3 and FIG. 4) reaches the downlink classifier, the downlink classifier may identify the downlink service traffic, mark the downlink service traffic with the corresponding steering path identifier and steer the marked downlink service traffic to the Gi-LAN for corresponding service. Herein, if the uplink classifier is deployed on the PGW, a specific identification flow is as mentioned above, and if the PGW in the network has no traffic identification function but the TDF is deployed and the TDF has the traffic identification function, the uplink classifier may be deployed on the TDF, but a specific identification flow has the following difference: first, a service traffic subjected to downlink value-added service is directly steered to the PGW, and the TDF only processes an uplink service traffic and an uplink and downlink jointly detected service traffic.

In the embodiment of the disclosure, on the basis of the second implementation manner for Step 21 and the second implementation manner for Step 22, after the uplink classifier identifies the steering path identifier of the downlink service traffic, the steering path identifier of the downlink service traffic and the description information of the downlink service traffic may also be directly be sent to the Gi-LAN for downlink value-added service in a data packet manner, and are sent to a user.

In a specific embodiment of the disclosure, on the basis of the second implementation manner for Step 22, when the uplink classifier may identify the steering path identifier of the uplink service traffic and the steering path identifier of the downlink service traffic, steering path identifiers (including the steering path identifier of the uplink service traffic and the steering path identifier of the downlink service traffic) may be notified to the downlink classifier, and at this moment, an indication of the steering path identifier is required to point out whether the steering path identifier of the downlink service traffic is included or not. The below is an implementation manner of sending the steering path identifier of the downlink service traffic. 24 characters of a Steering Policy Identifier (SPI) in a service path header are allocated, a first character is a character representing whether the steering path identifier of the downlink service traffic is included or not, for example, 0 represents NO and 1 represents YES. When the first character shows that the steering path identifier of the downlink service traffic is not included, 23 characters are all configured for the steering path identifier of the uplink service traffic; and when the steering path identifier of the downlink service traffic is included, 2 to 12 characters are configured to represent the steering path identifier of the uplink service traffic, and 13 to 23 characters are configured to represent the steering path identifier of the downlink service traffic.

In a specific embodiment of the disclosure, the downlink classifier may further obtain the steering path identifier of the downlink service traffic in the following manner: a policy control is configured, and the policy controller directly sends the steering path identifier of the downlink service traffic to the downlink classifier.

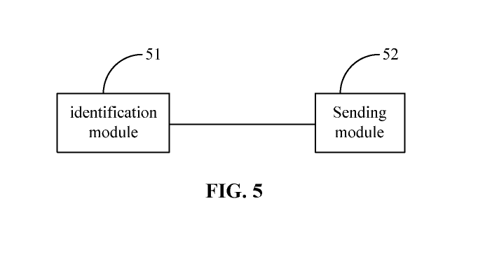

As shown in FIG. 5, an embodiment of the disclosure further provides a service traffic steering device, which is applied to an uplink classifier, the device including:

an identification module 51, configured to identify a steering path identifier of a downlink service traffic according to a service traffic steering policy; and

a sending module 52, configured to send the steering path identifier of the downlink service traffic and description information of the downlink service traffic to a downlink classifier to enable the downlink classifier to mark the downlink service traffic according to the steering path identifier of the downlink service traffic, wherein the uplink classifier and the downlink classifier are deployed in different network devices.

Optionally, the identification module 51 includes:

a first obtaining unit, configured to, when the steering path identifier of the downlink service traffic may be directly identified according to an uplink service traffic, directly identify the uplink service traffic to obtain the steering path identifier of the downlink service traffic according to the service traffic steering policy.

Optionally, the identification module 51 includes:

a first unit, configured to, when the steering path identifier of the downlink service traffic may not be directly identified according to the uplink service traffic, receive the downlink service traffic; and

a second obtaining unit, configured to identify states of the uplink service traffic and the downlink service traffic to obtain the steering path identifier of the downlink service traffic according to the service traffic steering policy.

Optionally, the sending module 52 includes:

a second unit, configured to send the steering path identifier of the downlink service traffic and the description information of the downlink service traffic to the downlink classifier through signaling interface(s).

Optionally, the sending module 52 includes:

a third unit, configured to send the steering path identifier of the downlink service traffic and the description information of the downlink service traffic to the downlink classifier through a policy controller.

Optionally, the sending module 52 includes:

a fourth unit, configured to steer a data packet to the downlink classifier through a network, the data packet containing the steering path identifier of the downlink service traffic and the description information of the downlink service traffic.

It is important to note that the service traffic steering device provided by the embodiment of the disclosure and applied to the uplink classifier is a device applying the abovementioned service traffic steering method applied to the uplink classifier, that is, all the embodiments of the method are applied to the device, and the same or similar beneficial effects may be achieved.

An embodiment of the disclosure further provides an uplink classifier, which includes the abovementioned service traffic steering device.

An embodiment of the disclosure further provides a PDN gateway, which includes the abovementioned uplink classifier.

An embodiment of the disclosure further provides a traffic detection function, which includes the abovementioned uplink classifier.

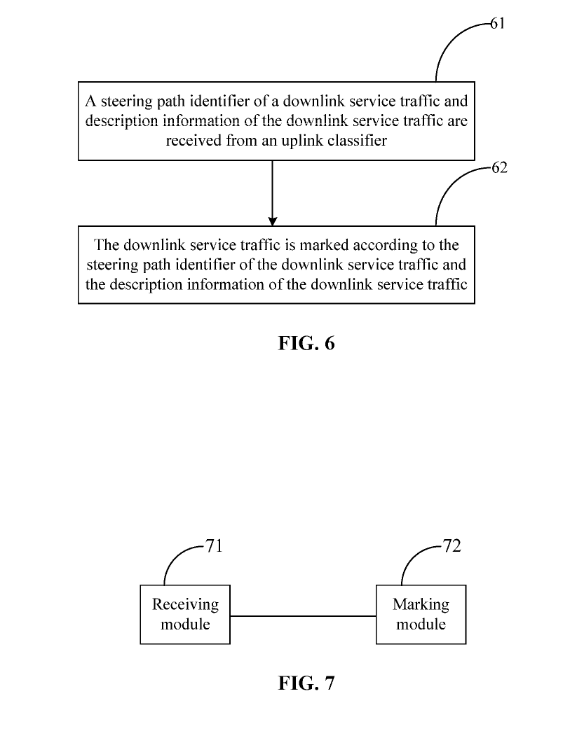

As shown in FIG. 6, an embodiment of the disclosure further provides a service traffic steering method, which is applied to a downlink classifier, the method including the following steps.

In Step 61, a steering path identifier of a downlink service traffic and description information of the downlink service traffic are received from an uplink classifier.

In Step 62, the downlink service traffic is marked according to the steering path identifier of the downlink service traffic and the description information of the downlink service traffic, wherein the uplink classifier and the downlink classifier are deployed in different network devices.

Optionally, in the embodiment of the disclosure, before Step 61 is executed, the method further includes that: the downlink service traffic is received; it is determined that no steering path identifier corresponding to the downlink service traffic is recorded per se; and the downlink service traffic is steered to the uplink classifier to enable the uplink classifier to identify the steering path identifier of the downlink service traffic.

Optionally, in the embodiment of the disclosure, Step 61 includes that: the steering path identifier of the downlink service traffic and the description information of the downlink service traffic are received from the uplink classifier through signaling interface(s).

Optionally, in the embodiment of the disclosure, Step 61 includes that: the steering path identifier of the downlink service traffic and the description information of the downlink service traffic are received from the uplink classifier through a policy controller.

Optionally, in the embodiment of the disclosure, Step 61 includes that: a data packet steered by the uplink classifier through a network is received, the data packet containing the steering path identifier of the uplink service traffic, the steering path identifier of the downlink service traffic and the description information of the downlink service traffic; and the steering path identifier of the downlink service traffic and the description information of the downlink service traffic are acquired from the data packet.

In a specific embodiment of the disclosure, corresponding to the abovementioned service traffic steering method applied to the uplink classifier, that is, when the uplink classifier sends the steering path identifier of the downlink service traffic and the description information of the downlink service traffic to the downlink classifier through the signaling interface(s) or the policy controller or the data packet, the downlink classifier may receive the steering path identifier of the downlink service traffic and the description information of the downlink service traffic in a corresponding manner, and mark the downlink service traffic according to the steering path identifier of the downlink service traffic and the description information of the downlink service traffic.

As shown in FIG. 7, an embodiment of the disclosure further provides a service traffic steering device, which is applied to a downlink classifier, the device including:

a receiving module 71, configured to receive a steering path identifier of a downlink service traffic and description information of the downlink service traffic from an uplink classifier; and

a marking module 72, configured to mark the downlink service traffic according to the steering path identifier of the downlink service traffic and the description information of the downlink service traffic, wherein the uplink classifier and the downlink classifier are deployed in different network devices.

Optionally, the device further includes:

a fifth unit, configured to receive the downlink service traffic;

a sixth unit, configured to determine that no steering path identifier corresponding to the downlink service traffic is recorded per se; and

a seventh unit, configured to send the downlink service traffic to the uplink classifier to enable the uplink classifier to identify the steering path identifier of the downlink service traffic.

Optionally, the receiving module 71 includes:

an eighth unit, configured to receive the steering path identifier of the downlink service traffic and the description information of the downlink service traffic from the uplink classifier through signaling interface(s).

Optionally, the receiving module 71 includes:

a ninth unit, configured to receive the steering path identifier of the downlink service traffic and the description information of the downlink service traffic from the uplink classifier through a policy controller.

Optionally, the receiving module 71 includes:

a tenth unit, configured to receive a data packet steered by the uplink classifier through a network, the data packet containing the steering path identifier of the downlink service traffic and the description information of the downlink service traffic; and

an eleventh unit, configured to acquire the steering path identifier of the downlink service traffic and the description information of the downlink service traffic from the data packet.

It is important to note that the service traffic steering device provided by the embodiment of the disclosure and applied to the downlink classifier is a device applying the abovementioned service traffic steering method applied to the downlink classifier, that is, all the embodiments of the method are applied to the device, and the same or similar beneficial effects may be achieved.

An embodiment of the disclosure further provides a downlink classifier, which includes the abovementioned service traffic steering device.

In a specific embodiment of the disclosure, the downlink classifier may be positioned in a network address translation network element in the related technology. For example, a function of the downlink classifier is realized by enhancing network address translation.

An embodiment of the disclosure further provides a service traffic steering system, which includes the abovementioned uplink classifier, the abovementioned downlink classifier and a policy controller, the policy controller being configured to receive a steering path identifier of a downlink service traffic and description information of the downlink service traffic from the uplink classifier and send the steering path identifier of the downlink service traffic and the description information of the downlink service traffic to the downlink classifier.

Wherein, the policy controller has the steering path identifier of the downlink service traffic and the description information of the downlink service traffic, and is further configured to send the steering path identifier of the downlink service traffic and the description information of the downlink service traffic to the downlink classifier.

Wherein, the downlink classifier is further configured to receive the steering path identifier of the downlink service traffic and the description information of the downlink service traffic from the policy controller.

Wherein, the policy controller is further be configured to, when the steering path identifier of the downlink service traffic is required to be updated, send an updating rule to the downlink classifier.

In a specific embodiment of the disclosure, the policy controller may forward the steering path identifier of the downlink service traffic and description information of the downlink service traffic, which are sent by the uplink classifier, to the downlink classifier. The policy controller may also directly send its own steering path identifier of the downlink service traffic and description information of the downlink service traffic to the downlink classifier. Therefore, when the steering path identifier of the downlink service traffic is required to be updated, the policy controller may directly send the updating rule to the downlink classifier.

The above is the preferred implementation mode of the disclosure. It should be pointed out that those skilled in the art may further make a plurality of improvements and embellishments without departing from the principle of the disclosure and these improvements and embellishments shall also fall within the scope of protection of the disclosure.

1. A service traffic steering method, applied to an uplink classifier, the method comprising:
identifying a steering path identifier of a downlink service traffic according to a service traffic steering policy; and
sending the steering path identifier of the downlink service traffic and description information of the downlink service traffic to a downlink classifier to enable the downlink classifier to mark the downlink service traffic according to the steering path identifier of the downlink service traffic, wherein the uplink classifier and the downlink classifier are deployed in different network devices.

2. The method according to claim 1, wherein the step of identifying the steering path identifier of the downlink service traffic according to the service traffic steering policy comprises:
when the steering path identifier of the downlink service traffic can be directly identified according to an uplink service traffic, directly identifying the uplink service traffic to obtain the steering path identifier of the downlink service traffic according to the service traffic steering policy.

3. The method according to claim 1, wherein the step of identifying the steering path identifier of the downlink service traffic according to the service traffic steering policy comprises:
when the steering path identifier of the downlink service traffic cannot be directly identified according to the uplink service traffic, receiving the downlink service traffic; and
identifying states of the uplink and downlink service traffic to obtain the steering path identifier of the downlink service traffic according to the service traffic steering policy.

4. The method according to claim 2, wherein the step of sending the steering path identifier of the downlink service traffic and the description information of the downlink service traffic to the downlink classifier comprises:
sending the steering path identifier of the downlink service traffic and the description information of the downlink service traffic to the downlink classifier through signaling interface(s); or
sending the steering path identifier of the downlink service traffic and the description information of the downlink service traffic to the downlink classifier through a policy controller; or
steering a data packet to the downlink classifier through a network, the data packet containing the steering path identifier of the downlink service traffic and the description information of the downlink service traffic.

5. The method according to claim 3, wherein the step of sending the steering path identifier of the downlink service traffic and the description information of the downlink service traffic to the downlink classifier comprises:
sending the steering path identifier of the downlink service traffic and the description information of the downlink service traffic to the downlink classifier through signaling interface(s); or
sending the steering path identifier of the downlink service traffic and the description information of the downlink service traffic to the downlink classifier through a policy controller; or
steering a data packet to the downlink classifier through a network, the data packet containing the steering path identifier of the downlink service traffic and the description information of the downlink service traffic.

6. An uplink classifier, comprising: one or more processors and a memory storing computer-readable operation instructions, wherein when the computer-readable operation instructions in the memory are run, the processor is configured to:
identify a steering path identifier of a downlink service traffic according to a service traffic steering policy; and
send the steering path identifier of the downlink service traffic and description information of the downlink service traffic to a downlink classifier to enable the downlink classifier to mark the downlink service traffic according to the steering path identifier of the downlink service traffic, wherein the uplink classifier and the downlink classifier are deployed in different network devices.

7. The uplink classifier according to claim 6, wherein the processor is further configured to:
when the steering path identifier of the downlink service traffic can be directly identified according to an uplink service traffic, directly identify the uplink service traffic to obtain the steering path identifier of the downlink service traffic according to the service traffic steering policy.

8. The uplink classifier according to claim 6, wherein the processor is further configured to:
when the steering path identifier of the downlink service traffic cannot be directly identified according to the uplink service traffic, receive the downlink service traffic; and
identify states of the uplink and downlink service traffic to obtain the steering path identifier of the downlink service traffic according to the service traffic steering policy.

9. The uplink classifier according to claim 8, wherein the processor is further configured to:
send the steering path identifier of the downlink service traffic and the description information of the downlink service traffic to the downlink classifier through signaling interface(s); or
send the steering path identifier of the downlink service traffic and the description information of the downlink service traffic to the downlink classifier through a policy controller; or
steer a data packet to the downlink classifier through a network, the data packet containing the steering path identifier of the downlink service traffic and the description information of the downlink service traffic.

10. The uplink classifier according to claim 7, wherein the processor is further configured to:
send the steering path identifier of the downlink service traffic and the description information of the downlink service traffic to the downlink classifier through signaling interface(s); or
send the steering path identifier of the downlink service traffic and the description information of the downlink service traffic to the downlink classifier through a policy controller; or
steer a data packet to the downlink classifier through a network, the data packet containing the steering path identifier of the downlink service traffic and the description information of the downlink service traffic.

11. A service traffic steering method, applied to a downlink classifier, the method comprising:
receiving a steering path identifier of a downlink service traffic and description information of the downlink service traffic from an uplink classifier; and
marking the downlink service traffic according to the steering path identifier of the downlink service traffic and the description information of the downlink service traffic, wherein the uplink classifier and the downlink classifier are deployed in different network devices.

12. The method according to claim 11, before the step of receiving the steering path identifier of the downlink service traffic and the description information of the downlink service traffic from the uplink classifier, further comprising:
receiving the downlink service traffic;
determining that no steering path identifier corresponding to the downlink service traffic is recorded per se; and
steering the downlink service traffic to the uplink classifier to enable the uplink classifier to identify the steering path identifier of the downlink service traffic.

13. The method according to claim 12, wherein the step of receiving the steering path identifier of the downlink service traffic and the description information of the downlink service traffic from the uplink classifier comprises:
receiving the steering path identifier of the downlink service traffic and the description information of the downlink service traffic from the uplink classifier through signaling interface(s); or
receiving the steering path identifier of the downlink service traffic and the description information of the downlink service traffic from the uplink classifier through a policy controller; or
receiving a data packet steered by the uplink classifier through a network, the data packet containing the steering path identifier of the downlink service traffic and the description information of the downlink service traffic; and
acquiring the steering path identifier of the downlink service traffic and the description information of the downlink service traffic from the data packet.

14. The method according to claim 11, wherein the step of receiving the steering path identifier of the downlink service traffic and the description information of the downlink service traffic from the uplink classifier comprises:
receiving the steering path identifier of the downlink service traffic and the description information of the downlink service traffic from the uplink classifier through signaling interface(s); or
receiving the steering path identifier of the downlink service traffic and the description information of the downlink service traffic from the uplink classifier through a policy controller; or
receiving a data packet steered by the uplink classifier through a network, the data packet containing the steering path identifier of the downlink service traffic and the description information of the downlink service traffic; and
acquiring the steering path identifier of the downlink service traffic and the description information of the downlink service traffic from the data packet.

15. A downlink classifier, comprising: one or more processors and a memory storing computer-readable operation instructions, wherein when the computer-readable operation instructions in the memory are run, the processor is configured to:
receive a steering path identifier of a downlink service traffic and description information of the downlink service traffic from an uplink classifier; and
configured to mark the downlink service traffic according to the steering path identifier of the downlink service traffic and the description information of the downlink service traffic, wherein the uplink classifier and the downlink classifier are deployed in different network devices.

16. The downlink classifier according to claim 15, wherein the processor is further configured to:
receive the downlink service traffic;
determine that no steering path identifier corresponding to the downlink service traffic is recorded per se; and
steer the downlink service traffic to the uplink classifier to enable the uplink classifier to identify the steering path identifier of the downlink service traffic.

17. The downlink classifier according to claim 16, wherein the processor is further configured to:
receive the steering path identifier of the downlink service traffic and the description information of the downlink service traffic from the uplink classifier through signaling interface(s); or
receive the steering path identifier of the downlink service traffic and the description information of the downlink service traffic from the uplink classifier through a policy controller; or
receive a data packet steered by the uplink classifier through a network, the data packet containing the steering path identifier of the downlink service traffic and the description information of the downlink service traffic; and
acquire the steering path identifier of the downlink service traffic and the description information of the downlink service traffic from the data packet.

18. The downlink classifier according to claim 15, wherein the processor is further configured to:
receive the steering path identifier of the downlink service traffic and the description information of the downlink service traffic from the uplink classifier through signaling interface(s); or
receive the steering path identifier of the downlink service traffic and the description information of the downlink service traffic from the uplink classifier through a policy controller; or
receive a data packet steered by the uplink classifier through a network, the data packet containing the steering path identifier of the downlink service traffic and the description information of the downlink service traffic; and
acquire the steering path identifier of the downlink service traffic and the description information of the downlink service traffic from the data packet.
